(19) United States
(12) Patent Application Publication
(10) Pub. No.: US 2008/0149255 A1
(43) Pub. Date: Jun. 26, 2008

(54) CERAMIC COMPOSITE ARTICLE MANUFACTURE USING THIN PLIES

(75) Inventors: Stephen Mark Whiteker, Covington, KY (US); Douglas M. Carper, Trenton, OH (US); Suresh Subramanian, Mason, OH (US); James D. Steibel, Mason, OH (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 11/613,576

(22) Filed: Dec. 20, 2006

(51) Int. Cl. B32B 37/06; B32B 37/00; B32B 38/10

(52) U.S. Cl. 156/89.11; 156/60; 156/247

(57) ABSTRACT

Thin plies used to manufacture components having changes in contour and changes in thickness and in fabricating thin cross-sections utilizing scrims. A scrim is applied to the surface of a thin, high temperature CMC prepreg ply. The scrim assists in maintaining the integrity of the thin ply during handling and lay-up operations thereby preventing damage to the thin plies and the lay-up. The scrim is a thin supportive layer applied to the surface of a thin prepreg to improve its handling characteristics, such as by preventing wrinkling. The scrim can be a coarse or fine mesh of thin or heavy fiber applied as a reinforcement. The scrim can be a temporary removable structure or can be incorporated into the component as part of the thin ply. The structure and composition of the scrim will be dependent upon whether the scrim is a temporary removable structure or whether it is incorporated permanently into the component.

### FIELD OF THE INVENTION

The present invention is directed to the preparation of thin ceramic matrix composite (CMC) plies and their use in fabricating a CMC component.

### BACKGROUND OF THE INVENTION

In order to increase the efficiency and the performance of gas turbine engines so as to provide increased thrust-to-weight ratios, lower emissions and improved specific fuel consumption, engine turbines are tasked to operate at higher temperatures. As the higher temperatures reach and surpass the limits of the material comprising the components in the hot section of the engine and in particular the turbine section of the engine, new materials must be developed.

As the engine operating temperatures have increased, new methods of cooling the high temperature alloys comprising the combustors and the turbine section components have been developed. For example, ceramic thermal barrier coatings (TBCs) are applied to the surfaces of components in the stream of the hot effluent gases of combustion to reduce the heat transfer rate and to provide thermal protection to the underlying metal and allow the component to withstand higher temperatures. These improvements help to reduce the peak temperatures and thermal gradients. Cooling holes are also introduced to provide film cooling to improve thermal capability or protection. Simultaneously, ceramic matrix composites have been developed as substitutes for the high temperature alloys. The ceramic matrix composites (CMCs) in many cases provide an improved temperature and density advantage over metals, making them the material of choice when higher operating temperatures and/or reduced weight are desired.

A number of techniques have been used in the past to manufacture hot section turbine engine components, such as turbine airfoils, using ceramic matrix composites. However, such techniques have resulted in difficulties related to the small features of gas turbine engine components, such as found in helicopter engines. One method of manufacturing CMC components, set forth in U.S. Pat. Nos. 5,015,540, 5,330,854, and 5,336,350, incorporated herein by reference in their entirety and assigned to the assignee of the present invention, relates to the production of silicon carbide matrix composites containing fibrous material that is infiltrated with molten silicon, herein referred to as the Silcomp process. The fibers generally have diameters of about 140 micrometers (0.0055″) or greater, which prevents intricate, complex shapes having features on the order of about 0.030 inches, such as turbine blade components for small gas turbine engines, to be manufactured by the Silcomp process.

Other techniques, such as the prepreg melt infiltration process have also been used. However, the smallest cured thicknesses with sufficient structural integrity for such components have been in the range of about 0.030 inch to about 0.036 inch, since they are manufactured with standard prepreg plies, which normally have an uncured thickness in the range of about 0.009 inch to about 0.011 inch. With standard matrix composition percentages in the final manufactured component, the use of such uncured thicknesses results in final cured thicknesses in the range of about 0.030 inch to about 0.036 inch for multilayer ply components, which is too thick for use in small turbine engines having components requiring fine features.

Complex CMC parts for turbine engine application have been manufactured by laying up a plurality of plies. In areas in which there is a change in contour or change in thickness of the part, plies of different and smaller shapes are custom cut to fit in the area of the contour change or thickness change. These parts are laid up according to a complicated, carefully preplanned lay-up scheme to form a cured part. Not only is the design complex, the lay-up operations are also time-consuming and complex. Additionally, the areas of contour change and thickness change have to be carefully engineered based on ply orientation and resulting properties, since the mechanical properties in these areas will not be monolithic. Because the transitions between plies along contour boundaries are not smooth, these contours can be areas in which mechanical properties are not smoothly transitioned, which must be considered when designing the part and modeling the lay-up operations.

Still other techniques attempt to reduce the thickness of the prepreg plies used to make up the multi-layer plies by reducing the thickness of the fiber tows. Theoretically, such processes could be successful in reducing the ply thickness. However, practically, such thin plies are difficult to handle during processing, even with automated equipment. Some common problems include wrinkling of the thin plies, a manufacturing defect that can result in voids in the article, and a deterioration of the mechanical properties of the article, and possible ply separation. In addition, problems arise as airfoil hardware requires the ability to form small radii and relatively thin edges. The high stiffness of the fibers, typically silicon carbide, in the prepreg tapes or plies, can lead to separation when attempting to form the plies around tight bends and corners with small radii. This leads to degradation in the mechanical properties of the article in these areas with resulting deterioration in durability.

What is needed is a method of manufacturing CMC turbine engine components that permits the manufacture of features having a thickness, particularly at the edges in the range of about 0.015 inch to about 0.021 inch, as well as small radii, the radii also in the range of less than about 0.030 inches. In addition, a method of manufacturing CMC turbine engine components having features with a thickness less than about 0.021 inch is also needed.

### SUMMARY OF THE INVENTION

The present invention utilizes thin plies to manufacture components having changes in contour and changes in thickness. The thin plies are also used in producing components having thin cross-sections.

A scrim is applied to the surface of a thin, high temperature CMC prepreg ply that assists in maintaining the integrity of the ply during handling and lay-up operations. Maintaining integrity as used herein means preventing damage to the thin plies and the lay-up, such as wrinkling. As used herein, a scrim is a thin supportive layer applied to the surface of a thin prepreg to improve its handling characteristics. The scrim can be a coarse or fine mesh of thin or heavy fiber applied as a reinforcement. The scrim can be a temporary removable structure or can be incorporated into the component as part of the thin ply. The structure and composition of the scrim will be dependent upon whether the scrim is a temporary removable structure or whether it is incorporated permanently into the component.

When the scrim is a temporary removable structure, and hence disposable, it can comprise a low cost reinforcing fabric made from a continuous filament yarn in an open mesh construction. Alternate structures to an open pattern include a film, a felt or fibrous material.

When the scrim is incorporated into the component, the scrim could include reinforcing fibers, in which case the orientation of the fiber bundles or tows should be applied in a preselected direction to provide the requisite strength. The fiber selected for the scrim must be suitably thin, consistent with the use of the thin layers in a thin section or at a change of contour. In addition, the composition of the filament yarn comprising the scrim must be compatible with the material comprising the thin layers of ply.

The scrim may also be incorporated into the component, whereby it is converted into matrix material. In this case, the scrim would be from a material that is readily wet by molten silicon, and preferably converts to silicon carbide (SiC). For example, a carbon-based scrim will convert to SiC during the molten silicon infiltration process.

An alternative approach for incorporating the scrim into the component involves using a “fugitive” fiber material, such as rayon, that thermally decomposes during polymer pyrolysis or burn-out operations at elevated temperatures prior to melt infiltration. In this case, the selected “fugitive” material cannot leave behind contaminants, and open channels that occur during the thermal decomposition may aid subsequent silicon infiltration.

The method reinforcing the thin high temperature ceramic matrix composite plies with scrim permits forming a lightweight, high temperature ceramic matrix composite component having the thin sections or large changes in contour. The method entails laying up a plurality of prior art high temperature ceramic matrix composite prepreg plies. Thin high temperature ceramic matrix composite prepreg plies having a thickness of 0.008 inches and less are provided for thin sections and for large changes in contour, the prepreg plies having high temperature capability. A reinforcing fabric having an open mesh construction, referred to as scrim layer, is provided and applied to the prepreg plies so that they can be handled without sustaining damage resulting in defects. The thin prepreg plies are laid up while maintaining the integrity of the plies. The thin plies are laid up at predetermined locations corresponding to geometries requiring a thin section or a large change of contour. The scrim layers are can be removed from the scrim during sequential lay-up operations or by thermal decomposition. Alternatively, the scrim layer can be incorporated into the component. If the scrim layer is removed by thermal decomposition or is incorporated into the component, melt infiltration of matrix material corresponding to the ply matrix material is required to eliminate voids and make the component fully dense. The lay-up is completed as required to form a prepreg component and then cured under heat and pressure to form a high temperature ceramic matrix composite component.

An advantage of the present invention is that the use of the scrim allows for lay-up of thin plies to form thin sections or to be used at contours. The lay-up can be anisotropic, so that the thin sections, areas in which thickness is changed and contours can be provided with directional strength as needed, so that strength does not have to be sacrificed at these locations.

An advantage of the present invention is that the application of the scrim to the thin plies allows the plies to be handled and laid up, while avoiding the problems previously identified with the handling and lay-up of thin plies.

Since thin plies can be handled, plies having a thickness of 8 mils (0.008 inches) and less can be utilized in CMC composites, allowing thin sections requiring the structural integrity of at least three plies, less than about 27 mils (0.027 inches) to be fabricated of CMC material.

Another advantage of the present invention is that, when the scrim is incorporated into the thin composite section or at contour changes, there is no need to include a removal operation for the scrim. Since the scrim is incorporated into the structure by an infiltration process and forms part of the CMC, the material choice for the fabric must be selected consistent with the material used for the thin ply.

Other features and advantages of the present invention will be apparent from the following more detailed description of the preferred embodiment, taken in conjunction with the accompanying drawings which illustrate, by way of example, the principles of the invention.

### DETAILED DESCRIPTION OF THE INVENTION

Scrim is used to improve the handling characteristics of thin, CMC plies. Scrim is a thin supportive layer applied to the surface of the thin prepreg to improve its handling characteristics. The scrim may be applied as a temporary, removable and disposable structure or it may be applied to improve the handling characteristics of the thin plies and incorporated into the CMC structure. The ultimate selection of the material and size of the scrim will depend upon whether the scrim is applied as a temporary handling aid or whether it is incorporated into the CMC structure. The scrim typically is unbacked material fabric with no matrix material in the interstitial areas. A thin layer of adhesive may be applied to the fabric solely to improve its adherence characteristics. It can comprise a woven fabric, an open weave material, a plurality of unidirectional tow or a thin mat of discontinuous fibrous material. The mat thickness may be as thin as about 0.0005 inches (0.5 mils), which is believed to approach the current limits as to scrim thickness, although improvements in technology may permit the manufacture of even thinner scrim.

Plies used to form CMC materials are comprised of filament tows in an uncured matrix material. As used herein, a tow means a bundle of continuous filaments. A filament means the smallest unit of fibrous material, having a high aspect ratio, having a diameter that is very small compared to its length. Fiber is used interchangeably with filament. As used herein, matrix is an essentially homogenous material into which other materials, fibers or tows specifically, are embedded. As used herein, a pre-preg-ply, or simply pre-preg, means a sheet of unidirectional tow, impregnated with matrix material, the matrix material being in resin form, partially dried, completely dried or partially cured. As used herein, a preform is a lay-up of pre-preg plies into a predetermined shape prior to curing of the pre-preg plies. The plies maintain a degree of stickiness or tackiness so that they can be adhered together during lay-up. The plies are generally anisotropic, having a direction of maximum strength that is in the same direction as the tow direction.

Plies used to form structural components have heretofore utilized tows having diameters of about 5.5 mils (0.0055 inches), embedded in an uncured or partially cured matrix material. The resulting plies have a thickness of from about 9-11 mils (0.009-0.011 inches). The amount of matrix material provided typically is determined by the tow diameter, as sufficient matrix material must be available to yield a void-free matrix. Providing tows having smaller diameters allows for the reduction of matrix material, which in turn results in plies having thicknesses of less than 9 mils. The problem with providing plies in sizes less than 9 mils is that they are difficult to handle and to lay up, resulting in unacceptable wrinkling or other types of damage compromising ply integrity.

CMC materials are finding use in aerospace applications and in certain components of aircraft engines. CMC materials are particularly useful as substitute materials in aircraft engines because of their low density (reduced weight) and excellent strength at elevated temperatures. The CMC materials find use in components such as turbine blades, combustor liners, exhaust liners, flaps and other structural applications throughout the engine hot section, including the combustor section, the turbine section and the exhaust section. In certain applications, there are very thin sections or drastic changes in section thickness or changes in contour, while strength must be maintained. Some typical examples include the trailing edge of turbine blades, and contours around cooling holes or passages. Such cooling holes and passages are provided for many hot section components. Where strength is required, at least three plies are utilized. Because of the standard ply thicknesses, the use of plies is limited to thicknesses of 27 mils and greater, and to changes in contour that are not too sharp.

Thin plies, less than 0.009 inches can be utilized using the present invention. Plies with thin tows and matrix materials having a thickness of 2.5-3.5 mils (0.0025-0.0035 inches) can be provided and can be handled using the present invention. The plies used for these turbine engine components can be comprised of tows that are significantly thinner resulting in thinner plies.

A mandrel is provided. The mandrel has a suitable surface. A suitable surface is one that is non-sticking with respect to at least one of the plies or the scrim. Preferably the mandrel is a cylindrical surface having a circumference that permits complete wrapping of the ply without the ply wrapping onto itself. Thus, if the ply that will be used for a lay-up is thirty six inches in length, the circumference of the cylindrical surface is greater than about thirty six inches (or an outer diameter of about 12 inches), the relationship between diameter (d) and circumference C being

C=π*d (1)

Ply and scrim are wrapped around the cylindrical surface, the size of the ply processed being limited only by the size of the cylinder. The scrim is applied to only one side of the ply. Because the ply is uncured or only partially cured, it has some adhesive properties that permit the scrim to adhere to the ply. A second cylindrical drum, much like a calendaring drum, can be used to contact the scrim and the ply together and to apply a pressure to the scrim and the ply to assure complete contact.

The ply/scrim combination can then be removed from the mandrel. Handling is facilitated by the scrim, which provides some additional strength to the ply. The ply can then be laid up in the conventional manner.

An embodiment of the invention allows the scrim to be applied to the ply on the mandrel or the ply to be applied to the scrim on the mandrel. Thin plies comprise directionally oriented tows embedded in a matrix and having a backing material. The tows may be unidirectional, which is most typical or may be a weave. The tows are embedded in a matrix, which is either uncured or partially cured. The matrix imparts a tackiness or stickiness to the plies. In a preferred embodiment, the ply is assembled onto the circumference of the cylinder with the backing facing the cylinder, allowing any wrinkles to be easily smoothed on the surface of the cylinder. If desired, the backing may be peeled or removed from the ply before application to the cylinder, or as it is being assembled to the cylinder or drum. The cylinder can be rotated at any convenient speed. The scrim, previously cut to a size consistent with the length and width of the ply, is then applied to the ply. The tackiness of the ply typically is sufficient to maintain the scrim in contact with the ply. If desired, the scrim can be pressed into the ply. This can be accomplished by hand. If a more precise application is required, the scrim can be assembled onto the ply using a second counter-rotating cylinder that can apply a constant force to the scrim. Using the second cylinder allows the applied force to be varied in a consistent fashion. After application of the scrim to the ply, the assembly can be removed from the cylinder or drum. The backing, if not previously removed, can now be removed, the scrim facilitating handling of the thin ply.

In an alternate embodiment, the scrim may be applied to the cylinder or drum. As noted, the scrim may include a small amount of adhesive, although this small amount of adhesive is not required, but can be utilized to improve the adhesion of the scrim to the ply. The ply is then applied over the scrim. The tackiness of the ply typically is sufficient to maintain the ply in contact with the scrim. If desired, the ply can be pressed against the scrim. This can be accomplished by hand. If a more precise application is required, the ply can be assembled onto the scrim using a second cylinder that can apply a winding tension to the ply as it is brought into contact against the scrim to enable sufficient contact between the scrim and the ply to facilitate bonding. After application of the ply to the scrim, the assembly can be removed from the cylinder or drum. The backing, if not previously removed, now can be removed, the scrim facilitating handling of the thin ply.

In a variation, the scrim having been pre-positioned onto a mandrel as discussed above, impregnated tows are directly wound onto the traversing mandrel over the scrim. The impregnated tows can have diameters significantly less than the standard 5.5 mil diameter commonly used to fabricate standard plies. The impregnated tows are maintained in winding tension to enable sufficient contact between the tows and the scrim. The impregnated tows are tacky, thereby promoting adhesion between the tows and the scrim as well as among the substantially parallel tows. As the assembly is uncoupled from the mandrel, the end result is a substantially thinner ply that can be laid up into a perform that does not have the ply defects associated with thin plies because of the support provided by the scrim.

The above-described fabrication options permit the scrim to be removed from the ply after lay-up, or allow the scrim to remain on the ply after lay-up and be incorporated into the component. When the scrim is to be removed from the ply after lay-up, the scrim material is applied solely for the purposes of temporary but improved handling of the thin ply. The assembly, a prepreg ply layer and the scrim, are sequentially laid up and the scrim layer is sequentially removed until preselected section thickness, typically 10 mils or less, or a thickness corresponding to a change in contour, is achieved. In this circumstance, the scrim material is disposable after removal. There are no restrictions of the size of type of material used for the removable scrim, except that the scrim be readily separable from the thin ply and not otherwise interact with the ply during the time it is in contact. In this circumstance, it may be advantageous to contact the ply and the scrim to each other sufficiently lightly that they can be readily separated, yet while permitting the scrim to provide support to the ply. The process entails laying up the assembly comprising the scrim-supported ply. After the ply has been laid up, the scrim can be removed. If the ply is laid up over another ply, the ply is first pressed against the underlying ply to assure good contact and adherence, while removing wrinkles. If no underlying ply, the ply is placed against the substrate, which may be a tooling fixture, while wrinkles are removed. The scrim is then removed. Ideally, the adhesion with the underlying material is greater than the force required to remove the scrim. However, some pressure may be lightly applied to the ply to prevent its movement as the scrim is removed. This is repeated for each ply as lay-up is continued until the lay-up is ready for processing. After lay-up is complete, the laid up component is then cured under heat and pressure, as is known in the art, such as by autoclave processing or a vacuum bag heat treatment and additional high temperature processing as required by the CMC material.

In an alternate embodiment, the scrim is applied to the ply to improve the handling characteristics of the ply. However, after application of the scrim to the ply and lay-up of the ply, the scrim material is not removed, but rather is incorporated into the component, such as by melt infiltration. Since the scrim is incorporated into the ply, the selection and size of scrim material has significant import. Since the plies are necessarily thin, the scrim material must be such that it does not add significantly to the thickness of the component section which is fabricated by this technique. The fiber or tow used in the scrim thus should be less than the tow used in standard plies, which is about 0.0055 inches. The tow or fiber that is incorporated into the component should preferably be less than about 5 mils and can have a diameter as small as 0.5 mils. This allows melt-infiltrated sections between the plies also to be very thin.

The tow or fiber forming the scrim that is incorporated into the component must be compatible with the ply material. Thus, if the ply material is silicon carbide/silicon carbide, it may be desirable to utilize silicon carbide fiber tow or carbon fiber tow for scrim and infiltrate silicon into the volume occupied by the scrim. The form of the scrim, whether discontinuous fiber mat, open weave, or unidirectional fiber, as well as the denier used, will depend on the mechanical properties requirements of the component. If the plies can provide the requisite mechanical properties, an open weave may be used. If some additional strength is required, a discontinuous fiber mat may satisfy the mechanical properties requirements. When maximum strength is required, a scrim comprising unidirectional fiber, substantially the same as used in the plies, is required.

The present invention enables the formation of thin sections or changes in thickness or changes in contour that can only be obtained with thin plies. These thin plies formed into substantially defect free-plies can be laid up to form desirable thin sections, such as the trailing edges of small blades having a radial height of less than two inches. Another use for these ply lay-ups can be at thin-to-thick transitions, such as for blade platforms, where thin plies are desirable for the transition between the sections, but heretofore have not been usable because of the tendency to form the defects previously discussed. CMC lay-ups require the use of at least three plies. The present invention allows three very thin plies to be laid up and cured in order to provide thin sections, changes in thicknesses or changes in contour by the use of plies or plies in combination with infiltration techniques. The resulting lay-ups provide a reduction of a three-ply combination from current thicknesses of about 27-33 mils (0.027-0.033 inches) to as little as about 7.5-10 mils (0.0075-0.010 inches) while eliminating defects associated with thin lay-ups without deteriorating the mechanical properties of the component.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of manufacturing a high temperature component, comprising the steps of:
providing a ceramic matrix composite prepreg ply having a thickness of 0.008 inches and less, the prepreg ply having high temperature capabilities;
providing a reinforcing fabric having an open mesh construction as a scrim layer;
applying the scrim layer to the prepreg ply to form an assembly; and
laying up the assembly while maintaining the integrity of the prepreg ply.

2. The method of claim 1 wherein the step of laying up the assembly includes laying up the assembly and removing the scrim layer.

3. The method of claim 2 wherein the step of laying up the assembly includes laying up subsequent assemblies sequentially over the first layer and sequentially removing the scrim layer until a preselected section thickness is achieved.

4. The method of claim 1 wherein the reinforcing fabric having an open mesh construction is selected from the group consisting of a continuous filament yarn with an open mesh construction, a film, a felt and a fibrous material,

5. The method of claim 4 wherein the continuous filament yarn is selected from the group consisting of a coarse mesh of a fine mesh.

6. The method of claim 1 wherein the step of providing a ceramic matrix composite prepreg ply having a thickness of 0.008 inches and less further includes providing a prepreg ply having a thickness of about 0.0025-0.003 inches.

7. The method of claim 3 wherein the step of laying up the assembly includes laying up two subsequent assemblies sequentially over the first layer and sequentially removing the scrim layer until the preselected section thickness is in the range of about 0.0075-0.010 inches.

8. The method of claim 1 wherein the step of laying up the assembly includes laying up subsequent assemblies sequentially over the first assembly until a preselected section thickness is reached.

9. The method of claim 8 whereby the scrim layer is incorporated into the laid-up assembly.

10. The method of claim 8 wherein the scrim layer includes tows of fiber bundles applied in a preselected direction, the scrim layer being compatible with the ceramic matrix composite prepreg ply material.

11. The method of claim 10 wherein the scrim layer includes tows of fibers having a thickness of less than about 0.005 inches.

12. The method of claim 10 wherein the scrim layer includes tows or fibers having a thickness in the range of about 0.0005 inches to less than about 0.005 inches.

13. The method of claim 10 further including a step of melt infiltrating the open mesh construction of the reinforcing fabric of the scrim with a matrix material corresponding to the ceramic matrix material of the composite prepreg ply.

14. The method of claim 13 wherein the prepreg ply is a silicon carbide/silicon carbide ceramic matrix composite, the scrim is selected from the group consisting of silicon carbide fiber tow and carbon fiber tow, and the melt infiltrated matrix material is silicon.

15. The method of claim 8 wherein the scrim layer is a fugitive fiber material, the method of claim 8 further including steps of decomposing the fugitive fiber material at elevated temperatures that thermally decomposes and melt infiltrating a matrix material corresponding to the ceramic matrix material of the composite prepreg ply in the open channels remaining after thermal decomposition of the fugitive fiber material.

16. A method of forming a lightweight, high temperature ceramic matrix composite component having the capability of forming thin sections and large changes in contour, comprising the steps of:
laying up a plurality of high temperature ceramic matrix composite prepreg plies;
providing thin high temperature ceramic matrix composite prepreg plies having a thickness of 0.008 inches and less, the prepreg plies having high temperature capabilities;
providing a reinforcing fabric having an open mesh construction as a scrim layer;
applying the scrim layer to the prepreg plies;
laying up the thin prepreg plies while maintaining the integrity of the plies at a predetermined location requiring a geometry selected from the group of a thin section and a large change of contour;
removing the scrim layers;
completing lay-up as required to form a prepreg component;
curing the ceramic matrix composite prepreg plies under heat and pressure to form a high temperature ceramic matrix composite component.

17. The method of claim 16 wherein the step of curing to form a high temperature ceramic matrix composite component includes forming a component for the hot section of an aircraft engine.

18. The method of claim 17 wherein the forming of a component for the hot section of an aircraft engine includes forming a component selected from the group consisting of turbine blades, combustor liners, exhaust liners and flaps.

19. The method of claim 16 wherein the step of laying up the thin prepreg plies includes laying up at least three prepreg plies.

20. The method of claim 16 wherein the steps of laying up the thin prepreg plies and removing the scrim layers includes sequentially removing the scrim layers from a thin ply prior to sequential application of another thin ply.

21. The method of claim 16 wherein the step of removing the scrim layers includes the steps of thermally decomposing the scrim layers as fugitive fiber material at elevated temperatures followed by melt infiltration of a matrix material corresponding to the ceramic matrix material of the thin composite prepreg plies.

22. A method of forming a lightweight, high temperature ceramic matrix composite component having the capability of forming thin sections and large changes in contour, comprising the steps of:
laying up a plurality of high temperature ceramic matrix composite prepreg plies;
providing thin high temperature ceramic matrix composite prepreg plies having a thickness of 0.008 inches and less, the prepreg plies having high temperature capabilities;
providing a reinforcing fabric having an open mesh construction as a scrim layer;
applying the scrim layer to the prepreg plies;
laying up the thin prepreg plies while maintaining the integrity of the plies at a predetermined location requiring a geometry selected from the group of a thin section and a large change of contour;
completing lay-up as required to form a prepreg component;
melt infiltrating matrix material corresponding to the ceramic matrix material of the thin, composite prepreg plies into the open mesh construction of the scrim layer, wherein the scrim layer is incorporated into the lay-up;
curing the ceramic matrix composite prepreg plies under heat and pressure to form a high temperature ceramic matrix composite component.

23. The method of claim 22 wherein the step of laying up the thin prepreg plies includes laying up at least three prepreg plies

24. The method of claim 22 wherein the step of curing to form a high temperature ceramic matrix composite component includes forming a component for the hot section of an aircraft engine.

25. The method of claim 24 wherein the forming of a component for the hot section of an aircraft engine includes forming a component selected from the group consisting of turbine blades, combustor liners, exhaust liners and flaps.
